(19) United States
(12) Patent Application Publication
(10) Pub. No.: US 2026/0351260 A1
(43) Pub. Date: Nov. 5, 2026

(54) PROCESSING METHOD AND ELECTRONIC DEVICE

(71) Applicant: Lenovo (Beijing) Limited, Beijing (CN)

(72) Inventors: Xin ZHAO, Beijing (CN); Zhaolin TENG, Beijing (CN)

(21) Appl. No.: 19/654,969

(22) Filed: Apr. 22, 2026

(30) Foreign Application Priority Data
Apr. 30, 2025 (CN) 202510573619.X

(51) Int. Cl. G10L 15/26; G10L 15/32

(52) U.S. Cl. CPC G10L 15/26; G10L 15/32

(57) ABSTRACT

A processing method includes activating a first processing model in response to determining that a first condition for speech-to-text transcription is met, processing first voice data based on the first processing model to generate a first text in response to determining that the first condition is met, activating a second processing model in response to determining that the first condition is no longer met, the second processing model using more processing resources than the first processing model, and processing the first voice data based on the second processing model to generate a second text, the second text being used to replace the first text.

### CROSS-REFERENCES TO RELATED APPLICATION

This application claims priority to Chinese Patent Application No. 202510573619.X filed on Apr. 30, 2025, the entire content of which is incorporated herein by reference.

### FIELD OF TECHNOLOGY

The present disclosure relates to the field of data processing technologies and, more specifically, to a processing method and an electronic device.

### BACKGROUND

At present, when users make calls on their mobile phones, they need to activate the phone's voice recognition model for voice recognition.

However, having the voice recognition model and the call running simultaneously can lead to low efficiency in voice recognition on mobile phones.

### SUMMARY

One aspect of this disclosure provides a processing method. The method includes activating a first processing model in response to determining that a first condition for speech-to-text transcription is met, processing first voice data based on the first processing model to generate a first text in response to determining that the first condition is met, activating a second processing model in response to determining that the first condition is no longer met, the second processing model using more processing resources than the first processing model, and processing the first voice data based on the second processing model to generate a second text. The second text is used to replace the first text.

Another aspect of this disclosure provides a processing device. The device includes a first activation unit, a first processing unit, a second activation unit, and a second processing unit. The first activation unit is configured to activate a first processing model in response to determining that a first condition for speech-to-text transcription is met. The first processing unit is configured to process first voice data based on the first processing model to generate a first text in response to determining that the first condition is met. The second activation unit is configured to activate a second processing model in response to determining that the first condition is no longer met, the second processing model using more processing resources than the first processing model. The second processing unit is configured to process the first voice data based on the second processing model to generate a second text. The second text is used to replace the first text.

Another aspect of this disclosure provides an electronic device. The electronic device includes one or more processors and one or more memories coupled to the one or more processors and storing a computer program that, when being executed, causes the one or more processors to activate a first processing model in response to determining that a first condition for speech-to-text transcription is met, process first voice data based on the first processing model to generate a first text in response to determining that the first condition is met, activate a second processing model in response to determining that the first condition is no longer met, the second processing model using more processing resources than the first processing model, and process the first voice data based on the second processing model to generate a second text, the second text being used to replace the first text.

### BRIEF DESCRIPTION OF THE DRAWINGS

To more clearly illustrate technical solutions in embodiments of the present disclosure, drawings for describing the embodiments are briefly introduced below. Obviously, the drawings described hereinafter are only some embodiments of the present disclosure, and it is possible for those ordinarily skilled in the art to derive other drawings from such drawings without creative effort.

FIG. 1 is a flowchart of a processing method according to some embodiments of the present disclosure.

FIG. 2 is a diagram of a voice call scenario according to some embodiments of the present disclosure.

FIG. 3 is a diagram of an audio output scenario according to some embodiments of the present disclosure.

FIG. 4 is a partial flowchart of the processing method according to some embodiments of the present disclosure.

FIG. 5 is a diagram of a speech-to-text transcription in a voice call scenario according to some embodiments of the present disclosure.

FIG. 6 is a diagram of sequentially generating a first text and a second text using a single model according to some embodiments of the present disclosure.

FIG. 7 is a diagram of separately generating the first text and the second text using two models according to some embodiments of the present disclosure.

FIG. 8 is a partial flowchart of the processing method according to some embodiments of the present disclosure.

FIG. 9 is a diagram of generating the first text using a first processing model according to some embodiments of the present disclosure.

FIG. 10 is a partial flowchart of the processing method according to some embodiments of the present disclosure.

FIG. 11 is a diagram of generating the second text using a second processing model according to some embodiments of the present disclosure.

FIG. 12 is a schematic structural diagram of a processing device according to some embodiments of the present disclosure.

FIG. 13 is a schematic structural diagram of an electronic device according to some embodiments of the present disclosure.

FIG. 14 is a flowchart of a process for implementing speech-to-text transcription in a voice call scenario according to some embodiments of the present disclosure.

### DETAILED DESCRIPTION

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

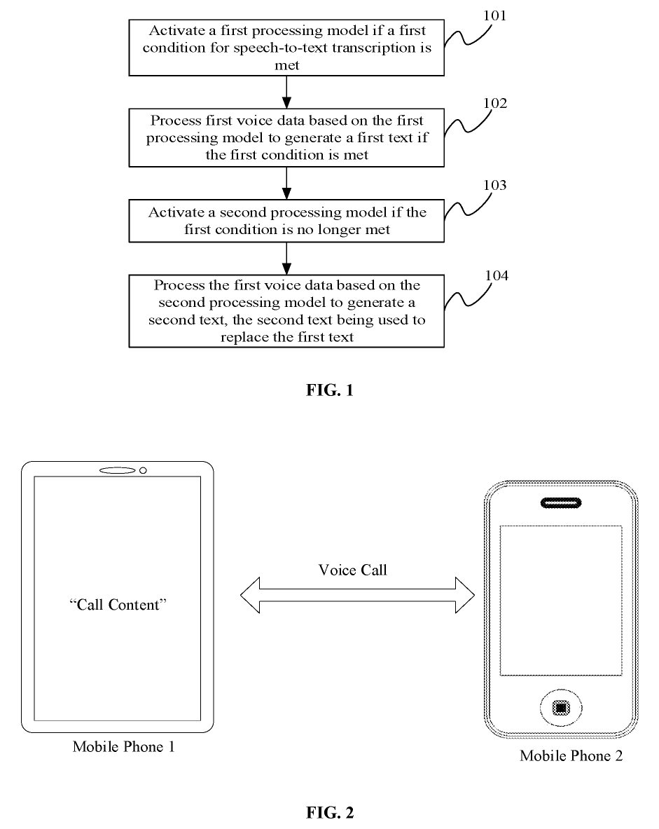

FIG. 1 is a flowchart of a processing method according to some embodiments of the present disclosure. The method can be applied to electronic devices capable of data processing, such as mobile phones, tablet computers, etc. The technical solution in this embodiment is mainly used to improve the efficiency of processing voice data. The method will be described in detail below.

101, activating a first processing model if a first condition for speech-to-text transcription is met.

102, processing first voice data based on the first processing model to generate a first text if the first condition is met.

In some embodiments, the first condition may represent the condition to transcribe voice data into text content.

In some embodiments, the first condition may include the electronic device entering a voice call state. In this case, the first voice data may be voice data exchanged between an electronic device and a counterparty device. When the electronic device enters a voice call state, the first condition is met. At this time, the first processing model can be activated to process the voice call in the voice call state to obtain the first text.

The processing model described in the present disclosure may be a voice recognition model capable of converting voice into text. The processing model may be an end-to-end deep learning model with multilingual and multitasking capabilities, and can be used for various voice processing tasks such as speech-to-text, speech translation, and speaker recognition for voice calls. The models range in size from a minimum of 39 million parameters to a maximum of 1,550 million parameters.

For example, as shown in FIG. 2, starting from the voice call between mobile phone 1 and mobile phone 2, the voice call received by mobile phone 1 is processed by the first processing model to obtain the first text, which is used to prompt the content of the call on mobile phone 1.

In other embodiments, the first condition may include the electronic device entering an audio output state. In this case, the first voice data may be audio data downloaded by an electronic device from another device and output. When the electronic device enters the audio output state, the first condition is met. At this time, the audio data in the audio output state can be processed by the first processing model to obtain the first text.

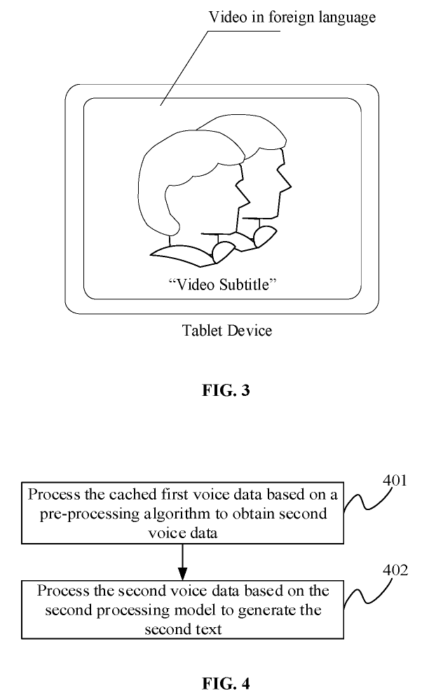

For example, as shown in FIG. 3, the tablet device downloads a video in foreign language from the Internet. Starting from the output of the video in foreign language from the tablet device, the audio signal of the video in foreign language is processed by the first processing model on the tablet device to obtain the first text. The first text can be used to prompt the subtitles of the video.

It should be noted that, in the embodiments of the present disclosure, while processing the first voice data based on the first processing model, the first voice data can be cached.

103, activating a second processing model if the first condition is no longer met.

In some embodiments, the processing resources consumed by the second processing model may exceed the processing resources consumed by the first processing model. Therefore, the time required for the second processing model and the first processing model to process the same voice data may be different.

It should be noted that the first condition no longer being met can be understood as the termination of the speech-to-text transcription process. That is, the first processing model can be activated when speech-to-text transcription begins, and the second processing model can be activated when speech-to-text transcription ends.

For example, in a voice call scenario, the first processing model can be activated to process the first voice data when the electronic device enters the voice call state, and the second processing model can be activated to process the voice after the electronic device ends the voice call state.

In another example, in an audio output scenario, starting from the point where the electronic device begins outputting audio data, the first processing model can be activated to process the audio data. Subsequently, after the electronic device stops outputting audio data, the second processing model can be activated to process the audio data.

104, processing the first voice data based on the second processing model to generate a second text, the second text being used to replace the first text.

In some embodiments, the processing resources consumed by the second processing model may exceed the processing resources consumed by the first processing model, the efficiency of the first processing model in processing the first audio data may be higher than the efficiency of the second processing model, and the accuracy of the second processing model in processing the first audio data may be higher than the accuracy of the first processing model. In this case, the first processing model can generate the first text more efficiently, while the second processing model can generate the second text more accurately. Therefore, when the first condition is met, the first text can be generated using the first processing model, which improves the efficiency of voice data processing. When the first condition is no longer met, the first text can be replaced by a more accurate second text generated using the second processing model. This satisfies the user’s need for efficient text generation when the first condition is met, and for accurate text generation when the first condition is no longer met.

It should be noted that the first processing model and the second processing model may be intelligent models for voice recognition based on machine learning algorithms.

Consistent with the present disclosure, when the first condition for speech-to-text transcription is met, a first processing model can be activated to process the voice data and generate a first text. When the first condition is no longer met, a second processing model can be activated to process the voice data to generate a second text that replaces the first text. The first processing model uses fewer processing resources than the second processing model, therefore, the first processing model can process voice data at a higher rate than the second processing model. Therefore, when the first condition is met, the first processing model enables faster processing of voice data, thereby enhancing the efficiency of voice data processing; conversely, when the first condition is not met, the voice data can be processed using the second processing model to generate superior text.

It should be noted that, in some embodiments, the second text can be paired with the audio data (i.e., the first voice data); Since the second text is more accurate, it may be used by the intelligent model to generate summaries or conclusions based on the second text.

The intelligent models described in the present disclosure may be machine learning models that can recognize natural language and/or other inputs (such as audio, video, images, tables, etc.) inputted to the target model, and perform comprehensive language processing tasks such as semantic analysis and question-and-answer, thereby generating outputs and/or responses related to the input.

The intelligent models described in the present disclosure can learn the features and rules of natural language by training on a large amount of diverse data, thereby being able to understand and generate natural language. Generally, the intelligent model will leverage hundreds of millions to hundreds of billions of model parameters (model parameters are variables that control the behavior of the target model) to capture complex relationships and patterns in natural language.

The intelligent models described in the present disclosure may take the form of generative models or generative language models (GLMs). For example, this may include large language models (LLMs) and generative pre-trained transformers (GPTs). The models described in the present disclosure may also be general purpose large language models, or specialized large models obtained through fine-tuning based on specific requirements. The present disclosure does not limit the type of model that can be used.

In some embodiments, the first voice data may also be cached. Based on this, after the second processing model is activated, the cached first voice data may be processed based on the second processing model to generate the second text.

For example, in a voice call scenario, from the time that the electronic device enters the voice call mode, the first processing model can be activated to process the first voice data, that is, the call audio, to quickly generate the first text. At the same time, the processed call audio can be cached. Subsequently, after the electronic device exits the voice call state, the second processing model can be activated to process the cached call audio to generate a more accurate second text to replace the first text.

In another example, in an audio output scenario, from the time that the electronic device outputs the audio data, the first processing model can be activated to process the first voice data, i.e., the audio data, to quickly generate the first text. At the same time, the processed audio data can be cached. After the electronic device stops outputting the audio data, the second processing model can be activated to process the cached audio data to generate a more accurate second text to replace the first text.

FIG. 4 is a partial flowchart of the processing method according to some embodiments of the present disclosure. In some embodiments, processing the first voice data based on the second processing model to generate the second text may include the following steps.

401, processing the cached first voice data based on a pre-processing algorithm to obtain second voice data.

In some embodiments, the pre-processing algorithm may include algorithms for performing noise reduction on the first voice data and algorithms for performing echo cancellation on the first voice data, and may also include other processing algorithms.

402, processing the second voice data based on the second processing model to generate the second text.

By pre-processing the first voice data, the second processing model can process the second voice data more accurately, thereby generating a more accurate second text.

In practice, the first voice data can be output in two separate streams. To improve the efficiency of speech-to-text transcription, when the first condition is met, a stream of first voice data can be directly provided to the first processing model, which will then process the voice data and quickly generate the first text. At the same time, the other stream of first voice data can be cached. In this way, if the first condition is not met, the cached first voice data can be pre-processed, such as noise reduction and echo cancellation, before being provided to the second processing model. This improves the accuracy of the second processing model in processing the first voice data, thereby improving the accuracy of the generated second text.

Take a voice call scenario as an example. As shown in FIG. 5, the original call audio received by mobile phone 1 is split into two streams. One stream of original call audio is directly provided to the first processing model, which performs voice recognition on the original audio data to quickly generate the first text while the other stream of original call audio is cached. After the voice call ends, the cached original voice call first goes through noise reduction and echo cancellation processing, and then gets provided to the second processing model for voice recognition to generate a more accurate second text, which in turn replaces the quickly generated first text.

Consistent with the present disclosure, the first voice data can be output via separate streams. To expedite speech-to-text transcription, a stream of first voice data can be directly provided to the first processing model. To achieve more accurate speech-to-text transcription, another stream of first voice data can be cached simultaneously. If the first condition is no longer met, pre-processing can be performed on the cached first voice data before providing the data to the second processing model. This satisfies the user's need for efficient text generation when the first condition is met, and also satisfies the user's need for accurate text generation when the first condition is no longer met.

Based on this, when caching the first voice data, the first voice data can be cached in a memory area. In some embodiments, if the remaining space in the memory area is less than a first threshold, the first voice data in the memory area can be stored in the disk storage area. The first voice data in the disk storage area may be provided to the second processing model.

The data read and write rates within the memory area are relatively fast, thereby avoiding any interference with the first processing model's processing of the first voice data. When the remaining space in the memory area is insufficient, the first voice data can be transferred, for example, to the disk storage area for permanent storage. This allows the second processing model to process the pre-processed voice data in the disk storage area when the first condition is no longer met to obtain a more accurate second text.

It should be noted that the memory area can be a queue storage structure, using a first-in-first-out data read/write mechanism.

For example, the memory area may be the memory area of a neural network processing unit (NPU), and the disk storage area may be a hard drive of a central processing unit (CPU).

In some embodiments, the first processing model and the second processing model may be the same model. The number of model parameters used by the first processing model to generate the first text may be less than the number of model parameters used by the first processing model (i.e., the second processing model) to generate the second text. That is, the first processing model can generate the first text and the second text using different numbers of model parameters. For example, the first processing model can generate the second text with all model parameters, and the first processing model can generate the first text with reduced model parameters.

Accordingly, the difference in the number of model parameters used by the first processing model to generate the first text versus the second text can result in corresponding differences in the efficiency and accuracy of the generated first text and second text.

Specifically, the number of model parameters used by the first processing model to generate the first text is relatively small, thereby resulting in higher efficiency in generating the first text. Conversely, the number of model parameters used by the first processing model to generate the second text is relatively large, thereby resulting in higher accuracy in generating the second text.

The simplified model parameters of the first processing model can be referred to as the reduced model parameters. As shown in FIG. 6, the first processing model processes the first voice data with reduced parameters to quickly generate the first text, and the first processing model also processes the first voice data using the complete model parameters (that is, prior to the simplification) to generate a more accurate second text.

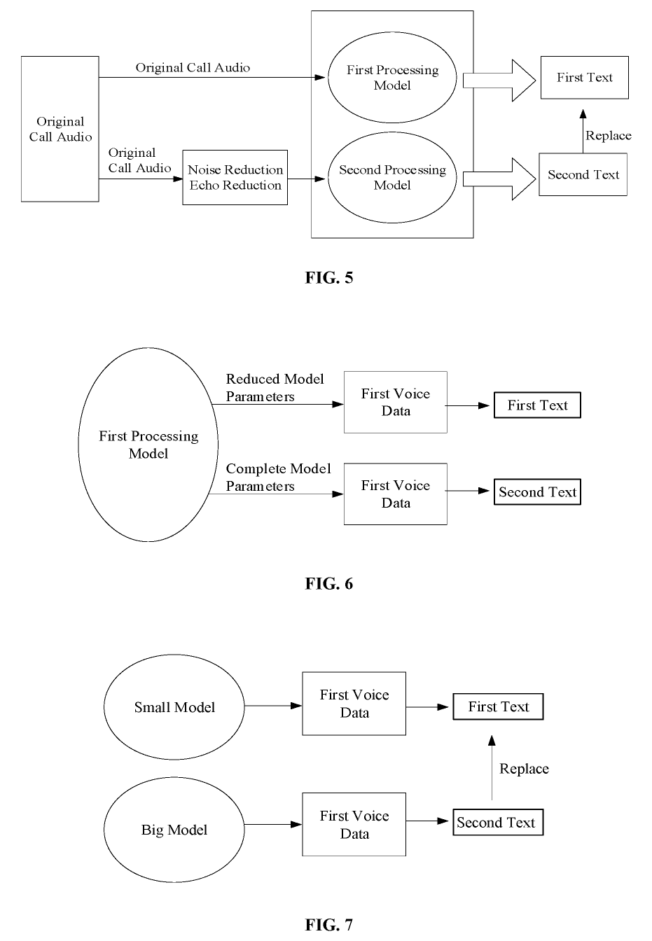

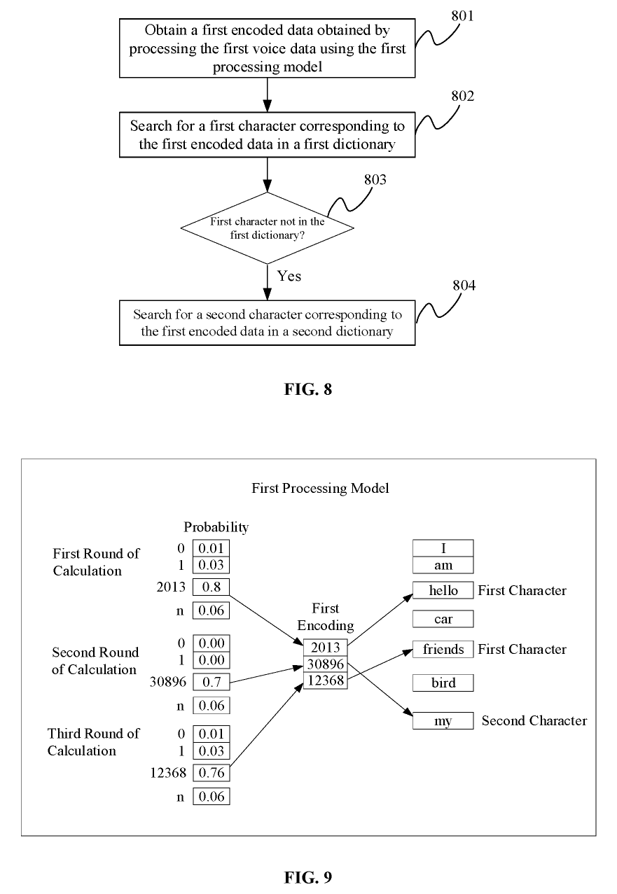

In some embodiments, the first processing model and the second processing model may be different models, and the number of model parameters of the first processing model may be less than the number of model parameters of the second processing model. For example, as shown in FIG. 7, the first processing model is a small model, the second processing model is a large model, and the number of model parameters in the small model is less than the number of model parameters in the large model. Therefore, the first processing model can generate the first text more efficiently, and the second processing model can generate the first text more accurately.

In some embodiments, when the first condition is met, the electronic device may be in a low-power state. For example, in a voice call scenario, when an electronic device is making a voice call, only the components that enable the voice call are running, while other components in the electronic device are not running. At this time, the electronic device is in a low-power state.

Based on this, the first processing model can be loaded into a first processor in the electronic device and executed to generate the first text. The second processing model can also be loaded into a second processor in the electronic device and executed to generate the second text. The operating power consumption of the first processor may be lower than the operating power consumption of the second processor, while the operating performance of the second processor may be higher than the operating performance of the first processor.

Therefore, when the electronic device is in a low-power state, the first model can be executed by a first processor with lower power consumption to quickly generate the first text. When the electronic device is no longer in a low-power state, the second processing model can be executed by a second processor with higher power consumption to obtain a more accurate second text. In this way, the users' need for efficient text generation when the first condition is met, and the user’s need for accurate text generation when the first condition is no longer met can both be met.

Take the first processing model and the second processing model as the same model as an example. When the first condition is met, the model parameters used to generate the first text in the first processing model can be loaded into the first processor. By running a first processing model with a smaller number of model parameters on the first processor, the first text can be generated faster. After the first condition is no longer met, the model parameters used to generate the second text in the second processing model can be loaded into the second processor. By running the second processing model with a larger number of model parameters on the second processor, the accuracy of the generated second text can be improved.

Take the first processing model and the second processing model as different processing as an example. When the first condition is met, the model parameters of the first processing model can be loaded into the first processor. By running a first processing model with a smaller number of model parameters on the first processor, the first text can be generated faster. After the first condition is no longer met, the model parameters of the second processing model can be loaded into the second processor. By running the second processing model with a larger number of model parameters on the second processor, the accuracy of the generated second text can be improved.

Consistent with the present disclosure, the first voice data can be output via two separate streams. To improve the efficiency of speech-to-text transcription, when the first condition is met, one first voice data stream can be directly provided to the first processor. A first processing model can be loaded onto the first processor. The first processor with lower power consumption can execute the first processing model to quickly generate the first text via the first processing model. At the same time, another stream of first voice data can be cached into the memory area corresponding to the first processor, such as the memory area of the NPU. With the processing of the first voice data, the remaining space in the memory area is steadily diminishing. Based on this, when the remaining space within the memory area falls below a first threshold, the first voice data located in the memory area can be stored in a disk storage area. Accordingly, when the first condition is not met, the first voice data located in the disk storage area can first undergo pre-processing, such as noise reduction and echo cancellation, before being provided to the second processor. A second processing model can be loaded onto the second processor. The second processing model with higher power consumption and high performance can execute the second processing model to more accurately process the first voice data to enhance the accuracy of the generated second text.

In some embodiments, the second processing model may operate when the load on the second processor meets an idle condition rule. For example, after the first condition is no longer met, when the second processor detects that the load meets the idle condition, it can read the first voice data from the disk storage area and perform pre-processing. The pre-processed voice data can then be processed by the second processing model loaded onto the second processor to generate the second text.

In other embodiments, the second processing model may operate when the second processor receives a trigger operation for the first voice data. For example, after the first condition is no longer met, the second processor can monitor whether a trigger operation is received for the first voice data. The trigger operation can indicate that the user requires a speech-to-text transcription operation. For example, when a user clicks a "Start Recognition" button on the interactive interface to indicate that the voice data needs to be processed. When a trigger operation is detected, the first voice data can be read from a disk storage area and pre-processed. The pre-processed voice data can then be processed by the second processing model loaded onto the second processor to generate the second text.

In some embodiments, the idle condition rule may include the amount of computing resources occupied by the second processor being less than a target threshold. The amount of computing resources may include the number of computing units in operation in the second processor, and the amount of space occupied in the memory area in the second processor. Accordingly, the idle condition rule may be: the number of computing units in an operational state in the second processor being less than a second threshold, and the amount of space occupied in the memory area of the second processor being less than a third threshold.

FIG. 8 is a partial flowchart of the processing method according to some embodiments of the present disclosure. In some embodiments, processing the first voice data based on the first processing model to generate the first text may include the following steps.

801, obtaining first encoded data obtained by processing the first voice data using the first processing model.

In each round of calculation on the first voice data, the first processing model may output multiple initial encoded data. Each initial encoded data may correspond to a calculated probability, and the magnitude of the calculated probability can represent the confidence level of the corresponding initial encoded data. Based on the initial encoded data and the corresponding calculated probabilities, the first encoded data can be selected from the initial encoded data.

For example, as shown in FIG. 9, the first processing model selects the first encoded data"2013" from 0 to n initial encoded data in the first round of calculation, selects the first encoded data "30896" in the second round of calculation, selects the first encoded data "12368" in the third round of calculation, etc.

In some embodiments, when the first condition is met, the electronic device may be in a low-power state. In this case, the model parameters of the first processing model can be loaded into the first processor with low power consumption, and the first processor can execute the first processing model to generate the first text.

802, searching for a first character corresponding to the first encoded data in a first dictionary.

803, determining whether the first character corresponding to the first encoded data is found in the first dictionary, and performing the process at 804 when the first character corresponding to the first encoded data is not found in the first dictionary.

804, searching for a second character corresponding to the first encoded data in a second dictionary.

In some embodiments, the first character or the second character may be used to form the first text. The character capacity of the second dictionary may be greater than the character capacity of the first dictionary. The first dictionary may be used to store characters retrieved from the second dictionary by the first processing model.

That is, a first dictionary may be deployed for the first processing model, while a second dictionary may serve as the official dictionary used by both the first and second processing models for speech-to-text transcription. The official dictionary can record the codes obtained by training and optimizing the first and second processing models, as well as the characters corresponding to those codes. The first dictionary can be used to cache the characters and the corresponding codes that the first processing model previously retrieved from the second dictionary during the processing of the first voice data. The first dictionary can be deployed in the cache area corresponding to the first processing model, that is, the memory area of the first processor. In addition, the character capacity stored in the first dictionary as a hot dictionary can be significantly smaller than the character capacity of the second dictionary. Based on this, the speed of finding the first character corresponding to the first encoded data in the first dictionary can be very fast. Therefore, when searching for the first character corresponding to the first encoded data, the search can be first performed in the first dictionary. In this way, if the first processing model has previously selected this first encoded data, the corresponding first character can be quickly found in the first dictionary. There is no need to search for the first character in the second dictionary, which can significantly speed up the processing efficiency of the voice data.

For example, as shown in FIG. 9, in the first round of calculation, the first processing model outputs the first encoded data "2013". Since "2013" already exists in the first dictionary and corresponds to "hello", the first character "hello" can be found in the first dictionary. In the second round of calculation, the first processing model outputs the first encoded data "30896". Since the corresponding first character is not found in the first dictionary, a search is then performed in the second dictionary. Since "30896" already exists in the second dictionary and corresponds to "my," the second character "my" can be retrieved from the second dictionary. In the third round of calculation, the first processing model outputs the first encoded data "12368". Since "12368" already exists in the first dictionary and corresponds to "friends", the first character "friends" can be found in the first dictionary. Based on this example, it can be seen that the efficiency of voice data processing can be significantly accelerated.

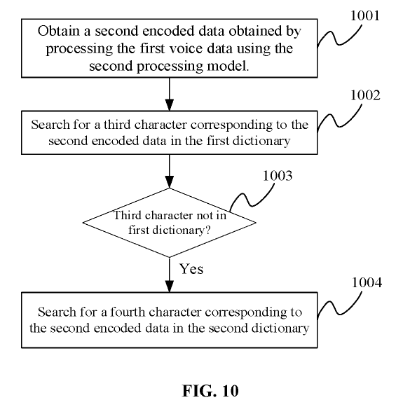

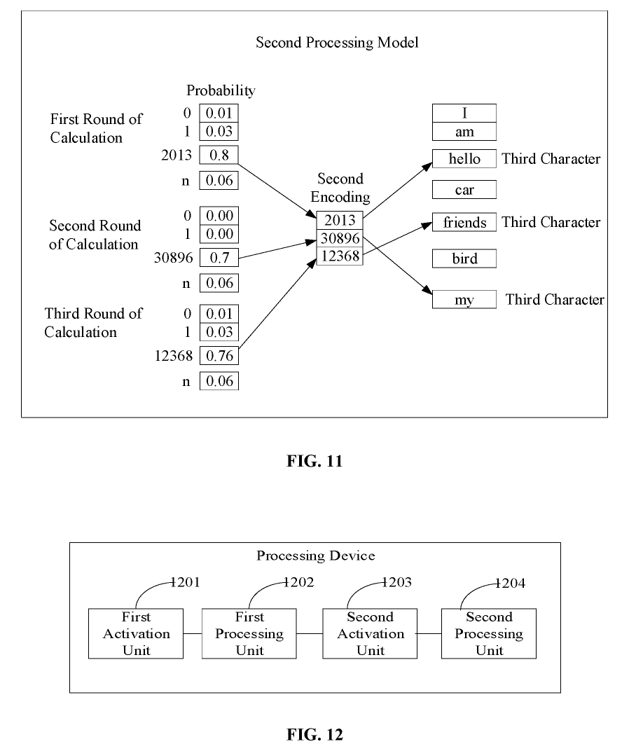

FIG. 10 is a partial flowchart of the processing method according to some embodiments of the present disclosure. In some embodiments, processing the first voice data based on the second processing model to generate the second text may include the following steps.

1001, obtaining the second encoded data that is obtained by processing the first voice data using the second processing model.

In some embodiments, in the process at 1001, the cached first voice data may be first processed based on a pre-processing algorithm to obtain second voice data, and the second voice data may then be processed based on the second processing model to generate the second text.

In each round of calculation on the first voice data (or the second voice data), the first processing model may output multiple initial encoded data. Each initial encoded data may correspond to a calculated probability, and the magnitude of the calculated probability can represent the confidence level of the corresponding initial encoded data. Based on the initial encoded data and the corresponding calculated probabilities, first encoded data can be selected from the initial encoded data.

For example, as shown in FIG. 11, the second processing model selected the second encoded data "2013" in the first round of calculation, the second encoded data "30896" in the second round of calculation, the second encoded data "12368" in the third round of calculation, etc.

It should be noted that after the first condition is no longer met, the electronic device may no longer be in the low-power state. The model parameters of the second processing model can then be loaded into the second processor, which has higher power consumption and performance. The second processor can execute the second processing model, which can read the cached first voice data from a disk storage area to generate the second text to replace the first text.

1002, searching for a third character corresponding to the second encoded data in the first dictionary.

1003, determining whether the third character corresponding to the second encoded data is found in the first dictionary, and performing the process at 1004 when the third character corresponding to the second encoded data is not found in the first dictionary.

1004, searching for a fourth character corresponding to the second encoded data in the second dictionary.

In some embodiments, the third character or the fourth character may be used to form the second text. The first dictionary may also be used to store characters retrieved by the second processing model from the second dictionary.

That is, after deploying the first dictionary, in addition to caching the characters and the corresponding codes that the first processing model previously looked up in the second dictionary during the processing of the first voice data, the first dictionary may also cache the characters and the corresponding codes that the second processing model adds from the second dictionary during the processing of the first voice data (or the second voice data). Therefore, in addition to accelerating the processing efficiency of voice data by using the first dictionary when processing the first voice data based on the first processing model, the processing efficiency of voice data can also be further accelerated by using the second dictionary when processing the first voice data (or the second voice data) based on the second processing model.

For example, as shown in FIG. 11, in the first round of calculation, the second processing model outputs the second encoded data "2013". Since "2013" already exists in the first dictionary and corresponds to "hello", the third character "hello" can be found in the first dictionary. In the second round of calculation, the second processing model outputs the second encoded data "30896". Since "30896" already exists in the first dictionary and corresponds to "my", the third character "my" can be found in the second dictionary. In the third round of calculation, the second processing model outputs the second encoded data "12368". Since"12368" already exists in the first dictionary and corresponds to "friends", the third character "friends" can be found in the first dictionary. Based on this example, it can be seen that the efficiency of voice data processing can be significantly accelerated.

In some embodiments, after generating the second text, the first dictionary may be deleted. When new first voice data needs to be transcribed into text, a new first dictionary can be created, and after the corresponding second text is generated, the first dictionary can be deleted. This can both speed up the processing efficiency of voice data and avoid the situation where the search efficiency decreases due to the increase in character capacity as voice processing accumulates.

In some embodiments, the process at 1001 can be executed automatically as soon as the first condition is no longer met, and the process at 1002 and the subsequent processes can be executed if the load on the second processor running the second processing model meets the idle condition rule. Alternatively, the process at 1002 and the subsequent processes can be executed when the second processor receives a trigger operation for the first voice data.

In some embodiments, starting from the process at 1001, the steps shown in FIG. 10 may be executed if the load on the second processor running the second processing model meets the idle condition rule. Alternatively, the process at 1001 and the subsequent steps may be executed when the second processor receives a trigger operation for the first voice data.

FIG. 12 is a schematic structural diagram of a processing device according to some embodiments of the present disclosure. The device can be deployed in electronic devices capable of data processing, such as mobile phones, tablet devices, etc. The technical solutions in this embodiment aim to improve the efficiency of voice data processing.

As shown in FIG. 12, the processing device includes a first activation unit 1201, a first processing unit 1202, a second activation unit 1203, and a second processing unit 1204.

In some embodiments, the first activation unit 1201 may be configured to activate a first processing model if a first condition for speech-to-text transcription is met.

In some embodiments, the first processing unit 1202 may be configured to, when the first condition is met, process first voice data based on the first processing model to generate a first text.

In some embodiments, the second activation unit 1203 may be configured to activate a second processing model if the first condition is no longer met, the processing resources consumed by the second processing model exceeding the processing resources consumed by the first processing model.

In some embodiments, the second processing unit 1204 may be configured to process the first voice based on the second processing model to generate a second text, the second text being used to replace the first text.

Consistent with the present disclosure, when the first condition for speech-to-text transcription is met, a first processing model can be activated to process the voice data and generate a first text. When the first condition is no longer met, a second processing model can be activated to process the voice data to generate a second text that replaces the first text. The first processing model uses fewer processing resources than the second processing model, therefore, the first processing model can process voice data at a higher rate than the second processing model. Therefore, when the first condition is met, the first processing model enables faster processing of voice data, thereby enhancing the efficiency of voice data processing; conversely, when the first condition is not met, the voice data can be processed using the second processing model to generate superior text.

In some embodiments, the first processing unit 1202 may be further configured to cache the first voice data.

Specifically, the first processing unit 1202 may be configured to process the cached first voice data based on a pre-processing algorithm to obtain the second voice data, and process the second voice data based on the second processing model to generate the second text.

In some embodiments, the first voice data may be cached into a memory area.

Specifically, the first processing unit 1202 may be configured to, when the remaining space in the memory area is less than a first threshold, store the first voice data in the memory area to a disk storage area, the first voice data in the disk storage area being provided to the second processing model.

In some embodiments, the first processing model and the second processing model may be the same model, and the number of model parameters used by the first processing model to generate the first text may be less than the number of model parameters used by the first processing model to generate the second text. Alternatively, the first processing model and the second processing model may be different models, and the number of model parameters of the first processing model may be less than the number of model parameters of the second processing model.

In some embodiments, when the first condition is met, the electronic device may be in a low-power state, and the first processing model may be loaded into a first processor in the electronic device and executed to generate the first text. The second processing model may be loaded into a second processor in the electronic device and executed to generate the second text. The power consumption of the first processor may be less than the power consumption of the second processor.

In some embodiments, the second processing model may operate when the load on the second processor meets an idle condition rule, or the second processing model may operate when the second processor receives a trigger operation for the first voice data. The idle condition rule may be the amount of computing resources occupied by the second processor being less than a target threshold.

In some embodiments, the first processing unit 1202 may be configured to obtain the first encoded data obtained by the first processing model processing the first voice data, search for the first character corresponding to the first encoded data in the first dictionary, and search for the second character corresponding to the first encoded data in the second dictionary if the first character corresponding to the first encoded data is not found in the first dictionary. The first character or the second character may be used to form the first text. The character capacity of the second dictionary may be greater than the character capacity of the first dictionary, and the first dictionary may be used to store the characters that the first processing model finds from the second dictionary.

In some embodiments, the second processing unit 1204 may be configured to obtain the second encoded data obtained by the second processing model processing the first voice data, search for the third character corresponding to the second encoded data in the first dictionary, search for the fourth character corresponding to the second encoded data in the second dictionary if the third character corresponding to the second encoded data is not found in the first dictionary. The third character or the fourth character may be used to form the second text, and the first dictionary may also be used to store the characters that the second processing model finds from the second dictionary.

In some embodiments, after generating the second text, the second processing unit 1204 may be further configured to delete the first dictionary. The search for the third character corresponding to the second encoded data in the first dictionary may be performed in response to a trigger operation on the first voice data.

It should be noted that for the specific implementation of each unit in this embodiment, reference can be made to the corresponding description above, and will not be described in detail here.

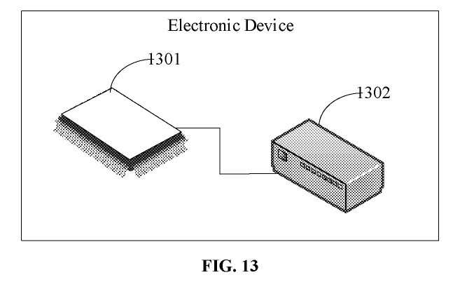

FIG. 13 is a schematic structural diagram of an electronic device according to some embodiments of the present disclosure. As shown in FIG. 13, the electronic device includes a memory 1301 for storing a computer program and data generated by executing of the computer program, and a processor 1302 for executing the computer program to: activate a first processing model if the first condition for speech-to-text transcription is met; process the first voice data based on the first processing model to generate the first text if the first condition is met; activate the second processing model if the first condition is no longer met, the processing resources consumed by the second processing model exceeding the processing resources consumed by the first processing model; process the first voice data based on the second processing model to generate the second text, the second text being used to replace the first text.

Consistent with the present disclosure, when the first condition for speech-to-text transcription is met, a first processing model can be activated to process the voice data and generate a first text. When the first condition is no longer met, a second processing model can be activated to process the voice data to generate a second text that replaces the first text. The first processing model uses fewer processing resources than the second processing model, therefore, the first processing model can process voice data at a higher rate than the second processing model. Therefore, when the first condition is met, the first processing model enables faster processing of voice data, thereby enhancing the efficiency of voice data processing; conversely, when the first condition is not met, the voice data can be processed using the second processing model to generate superior text.

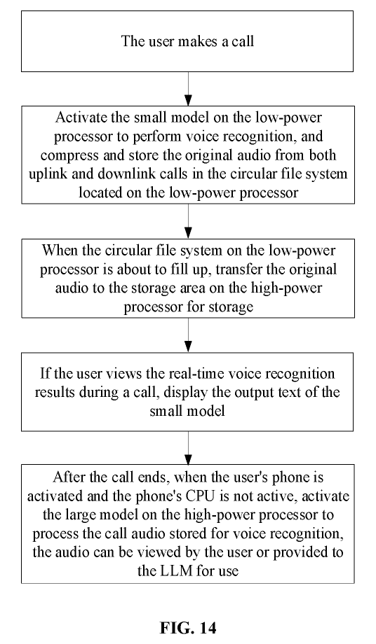

Take a mobile phone as an example. The mobile phone may be equipped with two processors: a low-power NPU and a high-power CPU. The NPU can be used to run small models (i.e., the first processing model), and the CPU can be used to run large models (i.e., the second processing model). Based on this, as shown in FIG. 14, the processing flow for voice recognition on a mobile phone is as follows.

First, when a user starts making a call, a small model on the low-power processor is activated to perform voice recognition, and the original audio of the uplink and downlink calls is compressed and stored in a circular file system (i.e., memory area) on the low-power processor. When the circular file system on the low-power processor is about to fill up, the original audio is transferred to the storage area on the high-power processor for storage. If a user views the real-time voice recognition results during a call, the output text of the small model (i.e., the first text) will be displayed. After the call ends, if the user's mobile phone is active and the phone's CPU is not active (i.e., the idle condition rule is met), the large model on the high-power processor can be activated to process the call audio stored for voice recognition. This audio can be viewed by the user or provided to other intelligent models such as the large language model (LLM) to use.

In the present disclosure, the embodiments are described in a gradual and progressive manner with the emphasis of each embodiment on an aspect different from other embodiments. The same or similar parts among the various embodiments may refer to each other. Since the disclosed device embodiment corresponds to the disclosed method embodiment, detailed description of the disclosed device is omitted, and reference can be made to the description of the methods for a description of the relevant parts of the device.

As will be appreciated by those of ordinary skill in the art, the embodiments disclosed herein can be implemented by way of electronic hardware, computer software, or a combination of the two. To clearly illustrate the interchangeability between hardware and software, components and steps of respective examples have already been described in a general way in terms of functions in the above description. These functions are to be executed by hardware manner or software manner depending upon the particular application of the technique process and design constraints. Those skilled in the art can use different methods to achieve the described functions with respect to each specific application, but such implementation should not be construed as going beyond the scope of the present disclosure.

The processes of the methods or algorithms described in conjunction with the embodiments of the present disclosure or a module or unit described in the present disclosure can be implemented with hardware, software components executed by a processor, or a combination thereof. The software modules may reside in a random-access memory (RAM), an internal memory, a read-only memory (ROM), an electrically programmable ROM, an erasable programmable ROM, a register, a hard disk, a removable disk drive, CD-ROM, or other types of storage media well known in the technical field. When executed by one or more processors, the software and/or hardware components implement the described function of the unit or module.

The foregoing description of the disclosed embodiments will enable a person skilled in the art to realize or use the present disclosure. Various modifications to the embodiments will be apparent to those skilled in the art. The general principles defined herein may be implemented in other embodiments without departing from the spirit or scope of the disclosure. Accordingly, the disclosure will not be limited to the embodiments shown herein, but is to meet the broadest scope consistent with the principles and novel features disclosed herein.

What is claimed is:

1. A processing method comprising:
activating a first processing model in response to determining that a first condition for speech-to-text transcription is met;
processing first voice data based on the first processing model to generate a first text in response to determining that the first condition is met;
activating a second processing model in response to determining that the first condition is no longer met, the second processing model using more processing resources than the first processing model; and
processing the first voice data based on the second processing model to generate a second text, the second text being used to replace the first text.

2. The method of claim 1, further comprising:
caching the first voice data; and
processing the first voice data based on the second processing model to generate the second text includes:
processing the cached first voice data based on a pre-processing algorithm to obtain second voice data; and
processing the second voice data based on the second processing model to generate the second text.

3. The method of claim 2, when the first voice data is cached into a memory area, further comprising:
storing the first voice data from the memory area into a disk storage area in response to determining that remaining space in the memory area is less than a first threshold, the first voice data in the disk storage area being used to provide to the second processing model.

4. The method of claim 1, wherein:
the first processing model and the second processing model are the same model, and the number of model parameters used by the first processing model to generate the first text is less than the number of model parameters used by the first processing model to generate the second text; or
the first processing model and the second processing model are different models, and the number of model parameters in the first processing model is less than the number of model parameters in the second processing model.

5. The method of claim 1, wherein:
an electronic device is in a lower-power state when the first condition is met;
the first processing model is loaded into a first processor in the electronic device and executed to generate the first text; and
the second processing model is loaded into a second processor in the electronic device and executed to generate the second text, the operating power consumption of the first processor being lower than the operating power consumption of the second processor.

6. The method of claim 5, wherein:
the second processing model is in operation when a load on the second processor meets an idle condition rule, or when the second processor receives a trigger operation for the first voice data, the idle condition rule being an amount of computing resources of the second processor occupied being less than a target threshold.

7. The method of claim 1, wherein processing the voice data based on the first processing model to generate the first text includes:
obtaining first encoded data obtained by the first processing model processing the first voice data;
searching for a first character corresponding to the first encoded data in a first dictionary; and
searching for a second character corresponding to the first encoded data in a second dictionary in response to determining that the first character corresponding to the first encoded data is not found in the first dictionary, the first character or the second character being used to form the first text, the second dictionary having a larger character capacity than the first dictionary, the first dictionary being used to store the characters that the first processing model retrieved in the second dictionary.

8. The method of claim 7, wherein processing the first voice data based on the second processing model to generate the second text includes:
obtaining second encoded data by using the second processing model to process the first voice data;
searching for a third character corresponding to the second encoded data in the first dictionary;
searching for a fourth character corresponding to the second encoded data in the second dictionary in response to determining that the third character corresponding to the second encoded data is not found in the first dictionary, the third character or the fourth character being used to form the second text, the first dictionary being used to store characters retrieved by the second processing model from the second dictionary.

9. The method of claim 8, after generating the second text, further comprising:
deleting the first dictionary.

10. A processing device comprising:
a first activation unit, the first activation unit being configured to activate a first processing model in response to determining that a first condition for speech-to-text transcription is met;
a first processing unit, the first processing unit being configured to process first voice data based on the first processing model to generate a first text in response to determining that the first condition is met;
a second activation unit, the second activation unit being configured to activate a second processing model in response to determining that the first condition is no longer met, the second processing model using more processing resources than the first processing model; and
a second processing unit, the second processing unit being configured to process the first voice data based on the second processing model to generate a second text, the second text being used to replace the first text.

11. The device of claim 10, wherein the first processing unit is further configured to:
cache the first voice data; and
the second processing unit is further configured to:
process the cached first voice data based on a pre-processing algorithm to obtain second voice data; and
process the second voice data based on the second processing model to generate the second text.

12. The device of claim 11, when the first voice data is cached into a memory area, the first processing unit is further configured to:
store the first voice data in the memory area into a disk storage area in response to determining that remaining space in the memory area is less than a first threshold, the first voice data in the disk storage area being used to provide to the second processing model.

13. The device of claim 10, wherein:
the first processing model and the second processing model are the same model, and the number of model parameters used by the first processing model to generate the first text is less than the number of model parameters used by the first processing model to generate the second text; or
the first processing model and the second processing model are different models, and the number of model parameters in the first processing model is less than the number of model parameters in the second processing model.

14. The device of claim 10, wherein:
an electronic device is in a lower-power state when the first condition is met;
the first processing model is loaded into a first processor in the electronic device and executed to generate the first text; and
the second processing model is loaded into a second processor in the electronic device and executed to generate the second text, the operating power consumption of the first processor being lower than the operating power consumption of the second processor.

15. The device of claim 14, wherein:
the second processing model is in operation when a load on the second processor meets an idle condition rule, or when the second processor receives a trigger operation for the first voice data, the idle condition rule being an amount of computing resources of the second processor occupied being less than a target threshold.

16. The device of claim 10, wherein the first processing unit is further configured to:
obtain first encoded data obtained by the first processing model processing the first voice data;
search for a first character corresponding to the first encoded data in a first dictionary; and
search for a second character corresponding to the first encoded data in a second dictionary in response to determining that the first character corresponding to the first encoded data is not found in the first dictionary, the first character or the second character being used to form the first text, the second dictionary having a larger character capacity than the first dictionary, the first dictionary being used to store the characters that the first processing model retrieved in the second dictionary.

17. The device of claim 16, wherein the second processing unit is further configured to:
obtain second encoded data by using the second processing model to process the first voice data;
search for a third character corresponding to the second encoded data in the first dictionary;
search for a fourth character corresponding to the second encoded data in the second dictionary in response to determining that the third character corresponding to the second encoded data is not found in the first dictionary, the third character or the fourth character being used to form the second text, the first dictionary being used to store characters retrieved by the second processing model from the second dictionary.

18. The device of claim 17, after generating the second text, the second processing unit is further configured to:
delete the first dictionary.

19. An electronic device comprising:
one or more processors; and
one or more memories coupled to the one or more processors and storing a computer program that, when being executed, causes the one or more processors to:
activate a first processing model in response to determining that a first condition for speech-to-text transcription is met;
process first voice data based on the first processing model to generate a first text if the first condition is met;
activate a second processing model in response to determining that the first condition is no longer met, the second processing model using more processing resources than the first processing model; and
process the first voice data based on the second processing model to generate a second text, the second text being used to replace the first text.

20. The electronic device of claim 19, wherein the one or more first processors are further configured to:
cache the first voice data;
process the cached first voice data based on a pre-processing algorithm to obtain second voice data; and
process the second voice data based on the second processing model to generate the second text.
